(19) United States
(12) Patent Application Publication
(10) Pub. No.: US 2024/0401554 A1
(43) Pub. Date: Dec. 5, 2024

(54) Submerged Hydroelectric Generator System

(71) Applicant: George Jaspert, Carlsbad, CA (US)

(72) Inventor: George Jaspert, Carlsbad, CA (US)

(21) Appl. No.: 18/807,480

(22) Filed: Aug. 16, 2024

Related U.S. Application Data
(63) Continuation-in-part of application No. 17/462,807, filed on Aug. 31, 2021.

(51) Int. Cl. F03B 13/10; F03B 11/00; F03B 11/08

(52) U.S. Cl. CPC F03B 13/10; F03B 11/002; F03B 11/004; F03B 11/08; F05B 2240/95

(57) ABSTRACT

A submerged hydroelectric generator system utilized for providing convenience when generating electrical energy from movement of water through a vertical peg stock. The vertical peg stock includes a first end and a second end, an intake valve disposed on the first end of the peg stock, at least one generator disposed within the peg stock, and an outlet valve disposed on the second end of the peg stock. The outlet valve includes a low frequency sound system, a plurality of aerator devices, and an air vent. The intake valve includes a filter, a valve regulator, and a time valve system. The outlet valve includes a vacuum-generation rotor or a turbofan engine that flushes water out of the peg stock. The submerged hydroelectric generator system also includes the outlet valve having a cuboctahedron shape.

### CROSS-REFERENCE TO RELATED APPLICATIONS

This Continuation-In-Part Application claims the benefit of U.S. Non-Provisional patent application Ser. No. 17/462,807 filed on Aug. 31, 2021. The above identified patent applications are herein incorporated by reference in their entirety to provide continuity of disclosure.

### BACKGROUND OF THE INVENTION

The present invention relates to a hydro-powered electric generator system. More particularly, the present invention provides a submerged hydroelectric generator system that is designed to work via energy generated from currently untapped and continuously moving water sources.

As the human population grows and expands into new geographic locations, the need for energy to power homes, infrastructures, businesses, and the like increases. Meeting this increasing demand for electricity consumption is a significant challenge in today's economy. Even though there have been improvements in electricity generation and a marked growth of alternative energy systems over the years, new and existing environmental concerns created have made urgent the need for innovation in the field of usable power generation. Green energy, wind farms, and solar farms have been installed to attempt to address some of these concerns, however, the need for renewable energy remains dire.

Hydroelectric power has shown promise as a clean source of renewable energy. One example of an effective hydroelectric power source is an arch-gravity dam, such as the Hoover Dam. These systems generally rely upon the use of water flow diversion to direct natural water flows through turbines to generate electricity. A disadvantage of these systems is that natural water flows may change over time. For example, the electric output of the Hoover Dam has decreased over time as the water level of Lake Mead has decreased.

Consequently, there is a need for an improvement in the field of electrical energy generation. The present invention substantially diverges in design elements from the known prior art while at the same time solves a problem faced when attempting to supply power to areas of large consumption. In this regard the present invention substantially fulfills these needs.

The submerged hydroelectric generator system works in a similar manner to the Hoover dam concept of a gravity-driven water flow. One difference is that the submerged hydroelectric generator system creates a flow of water in a completely submerged environment, as opposed to utilizing a naturally created flow of water, such as a waterfall or a river flow. By utilizing an artificially created water flow, the need to utilize specific locations, such as rivers, streams, reservoirs, or lakes is decreased, as the submerged hydroelectric generator system is capable of operation in any body of water of sufficient depth. Because of the high number of suitable locations for the submerged hydroelectric generator system, the overall system will be able to provide renewable energy to buildings, communities, coastal cities, islands, and to existing utility companies.

### SUMMARY OF THE INVENTION

In view of the foregoing disadvantages inherent in the known types of submerged hydroelectric generator systems now present in the prior art, the present invention provides a submerged hydroelectric generator system wherein the same may be utilized for providing convenience when generating energy from the movement of water through a peg stock.

The submerged hydroelectric generator system comprises a peg stock. The peg stock comprises a first end defined oppositely a second end. The first end is positioned such that water entering the first end of the peg stock will be gravitationally directed towards the second end of the peg stock. An intake valve is disposed at the first end of the peg stock. The intake valve is configured to selectively allow water to flow into the first end of the peg stock. At least one generator is disposed on the peg stock. The generators are designed to generate power from energy generated by water flow through the peg stock. An outlet valve is disposed on the second end of the peg stock. The outlet valve is configured to release water from the peg stock as water enters the peg stock.

It is an object of the present invention to provide a submerged hydroelectric generator system that is used in open water away from land.

It is an object of the present invention to provide a submerged hydroelectric generator system that is used away from a dam or other structure.

It is an object of the present invention to provide a submerged hydroelectric generator system that utilizes a vertical peg stock that has an open top to receive incoming water to power the submerged hydroelectric generator system.

It is an object of the present invention to provide a submerged hydroelectric generator system that is used in relatively shallow water as well as relatively deep water.

It is an object of the present invention to provide a submerged hydroelectric generator system that utilizes a cuboctahedron-shaped outlet valve.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of a submerged hydroelectric generator system.

FIG. 2 shows a demonstrative view of an embodiment of the submerged hydroelectric generator system in use.

FIG. 3 shows a demonstrative view of an onshore embodiment of the submerged hydroelectric generator system in use.

FIG. 4 shows a demonstrative view of a ship-mounted embodiment of the submerged hydroelectric generator system in use.

FIG. 5 shows a perspective view of an embodiment of the submerged hydroelectric generator system.

FIG. 6 shows a perspective view of an alternate embodiment of the submerged hydroelectric generator system.

### DETAILED DESCRIPTION OF THE INVENTION

Reference is made herein to the attached drawings. Like reference numerals are used throughout the drawings to depict like or similar elements of the submerged hydroelectric generator system. The figures are intended for representative purposes only and should not be considered to be limiting in any respect.

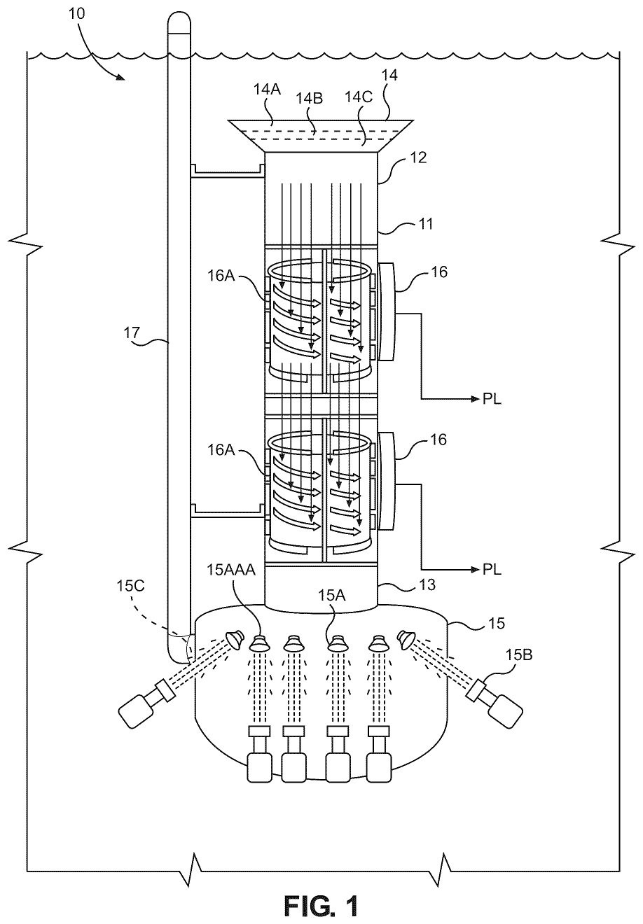

Referring now to FIG. 1, there is shown a perspective view of an embodiment of the submerged hydroelectric generator system 10. The submerged hydroelectric generator system 10 may comprise a peg stock 11. The peg stock 11 may define a first end 12 opposite a second end 13. In the illustrated embodiment, the peg stock 11 may be vertically oriented or the like. The peg stock 11 may be made of water-resistant materials, such that it may be placed in an underwater environment and be resistant to water damage over time. The height and diameter of the peg stock 11 may be of any desired length, size or dimension. Providing a peg stock 11 of an increased diameter will increase the eventual power output of the submerged hydroelectric generator system 10.

The peg stock 11 may comprise an intake valve 14 disposed proximate to the first end 12 of the peg stock 11. The intake valve 14 may be configured to receive water into the peg stock 11. Ideally, the intake valve 14 may be placed at a depth of at least approximately 50 feet beneath the surface of the body of water in which the submerged hydroelectric generator system 10 is placed, such that a continuous volume of water may enter the peg stock 11. In one embodiment, the volume of water entering the peg stock 11 may be controlled utilizing a valve regulator 14A, such as a time valve system 14B implemented upon the intake valve 14. The time valve system 14B may be designed to selectively permit volumes of water into the peg stock 11. In some embodiments, the intake valve 14 comprises a filter 14C. The filter 14C may be configured to prevent flotsam, debris, or aquatic wildlife from entering the peg stock 11.

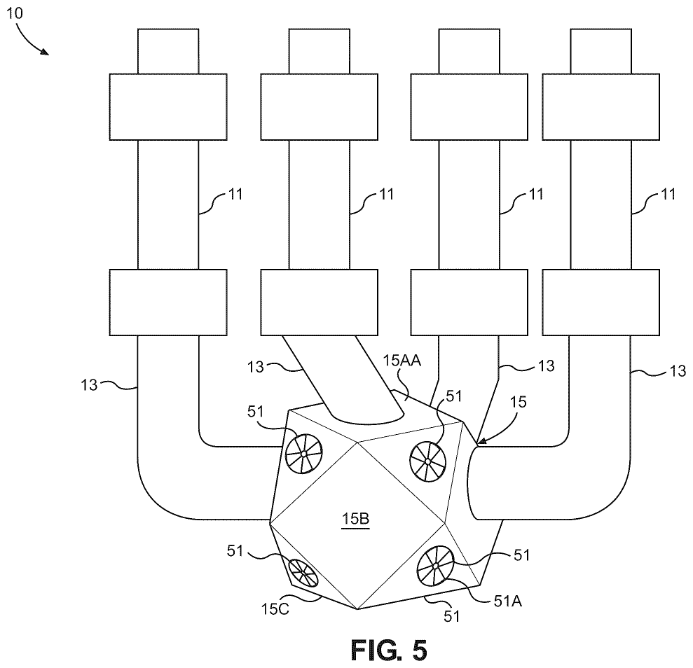

Opposite the intake valve 14, the peg stock 11 may comprise an outlet valve 15. The outlet valve 15 may be disposed proximate to the second end 13 of the peg stock 11. The outlet valve 15 may be configured to expel water from the peg stock 11. In the illustrated embodiment, the outlet valve 15 may comprise a low frequency sound system 15A and a plurality of aerator devices 15B. In such an embodiment, the low frequency sound system 15A will generate pressure within the outlet valve 15 and the aerator devices 15B will utilize compressed air bubbles to release the water from the outlet valve 15 and to maintain zero net head pressure. The low frequency sound system 15A may be a sound emitting speaker such as a subwoofer 15AAA or the like. The low frequency sound system 15A is explicitly defined that produces sound waves that typically fall within the approximate range of 20 Hz to 200 Hz, which is the lower end of the audible frequency spectrum. Therefore, the low frequency sound system is not any device that is capable of generating pressure, but rather a specific device that produces sound waves that typically fall within the approximate range of 20 to 200 Hz. The aerator devices 15B produce air bubbles using air drawn in from the surrounding environment. In the illustrated embodiment, air may be drawn in through an air vent 17. By expelling air and water, the outlet valve 15 may operate more efficiently. Furthermore, in some embodiments, additional mechanisms, such as a generation rotor (FIG. 5, (51A)) or a turbofan engine (FIG. 5, (51)), may be utilized to eject water from the outlet valve 15. The relatively low energy consumption of the low frequency sound system 15A and the aerator devices 15B reduces the energy consumption of the outlet valve 15, resulting in an increased net energy output. The outlet valve 15 may also comprise an air injection valve 15C.

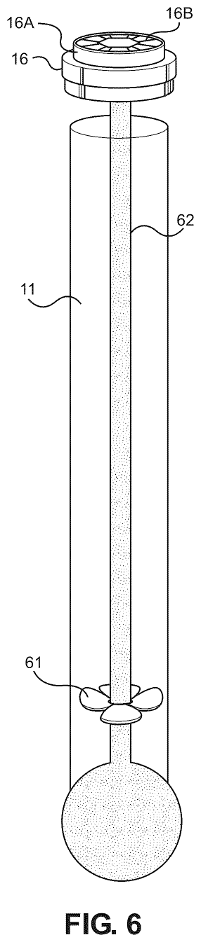

At least one generator 16 may be disposed within the peg stock 11 between the first end 12 and the second end 13. Each of the at least one generator 16 may be configured to gather energy from the action of the water entering the intake valve 14 falling downward upon the at least one generator 16. Furthermore, each of the at least one generator 16 may be adapted to operate in a subaquatic environment. In some embodiments, the at least one generator 16 comprises a power line PL extending outward therefrom, such that the at least one generator 16 may supply power to a power source. In the illustrated embodiment, a pair of spindle generators 16A are provided. The pair of spindle generators 16A may be designed to rotate as the water falls upon a plurality of internal fins (FIG. 6, 16B) defined by each of the pair of spindle generators 16. The size, voltage and output of the at least one generators 16 may vary depending on the size, location and environment of the submerged hydroelectric generator system 10. The use of the at least one generators 16 will increase the energy output of the submerged hydroelectric generator system 10.

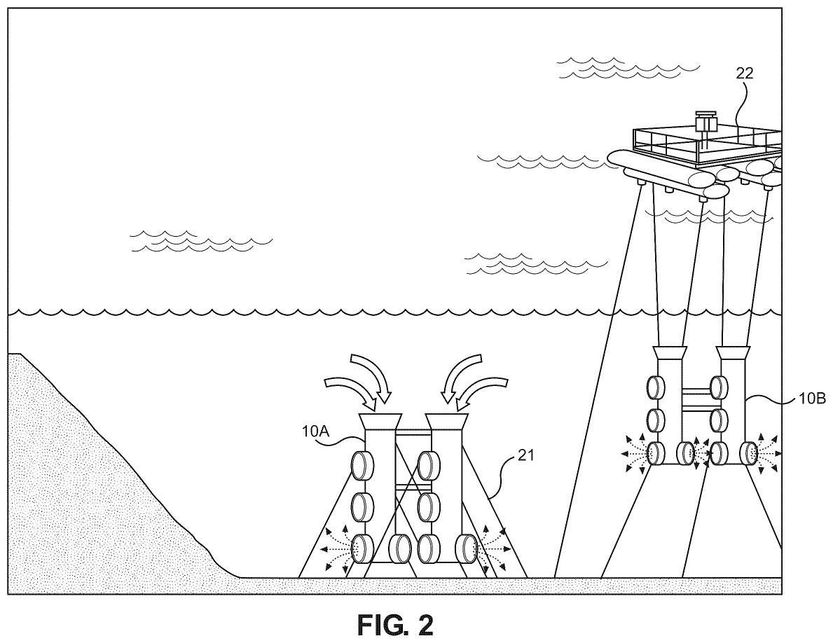

Referring now to FIG. 2, there is shown a demonstrative view of an embodiment of the submerged hydroelectric generator system 10 in use. The submerged hydroelectric generator system 10 may be installed in any desired body of water, such as an ocean, a sea, a lake, a river, a reservoir, or the like. In the illustrated embodiment, a pair of submerged hydroelectric generator systems 10A, 10B are shown in a natural body of water. Ideally the submerged hydroelectric generator system 10A, 10B will be installed at a depth of approximately 200 feet below the water surface level or greater. The depth of the underwater installation will protect the submerged hydroelectric generator systems 10A, 10B from natural phenomenon such as relatively high turbulent currents, hurricane turbulence, and above surface freezing conditions. The submerged hydroelectric generator system 10 may be operated approximately 800 feet beneath the water surface level during hurricanes to prevent or limit damage to the submerged hydroelectric generator system 10.

The first submerged hydroelectric generator system 10A may be anchored to a sea floor of a body of water via a plurality of tethers 21. The tethers 21 may be of a desired length to maintain the position of the first submerged hydroelectric generator system 10A at a desired depth. The tethers 21 may be installed via a flotation platform 22. Furthermore, in the illustrated embodiment each submerged hydroelectric generator system 10A, 10B comprises a pair of parallel oriented peg stocks 11. As such, each of the pair of submerged hydroelectric generator systems 10A, 10B is built with a redundancy to prevent power disruption in the event of a machine failure or scheduled maintenance.

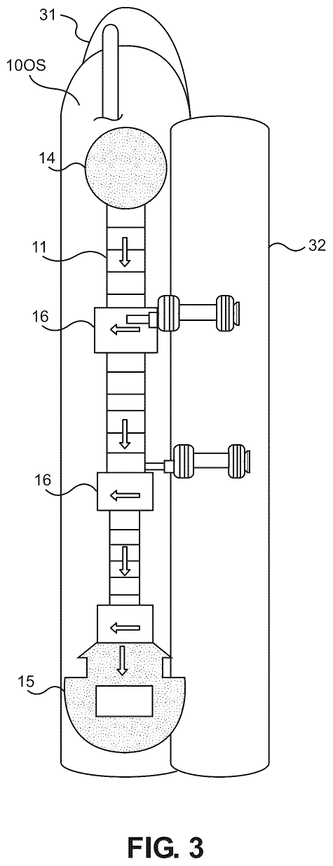

Referring now to FIG. 3, there is shown a demonstrative view of an onshore embodiment of the submerged hydroelectric generator system 10 in use. In one embodiment, the submerged hydroelectric generator system 10 may be installed in an onshore tower 100S. The submerged hydroelectric generator system 10 may comprise a system housing 31 in which the intake valve 14, the peg stock 11, the generators 16, and the outlet valve 15 are installed. The system housing 31 may be disposed adjacent to a fluid reservoir 32. As water enters the intake valve 14, passes through the peg stock 11 and the generators 16 and is expelled through the outlet valve 15, it will enter the fluid reservoir 32. Because of the fluid pressure generated as water is expelled into the fluid reservoir 32, water will re-enter the system housing 31 and once again pass through the intake valve 14.

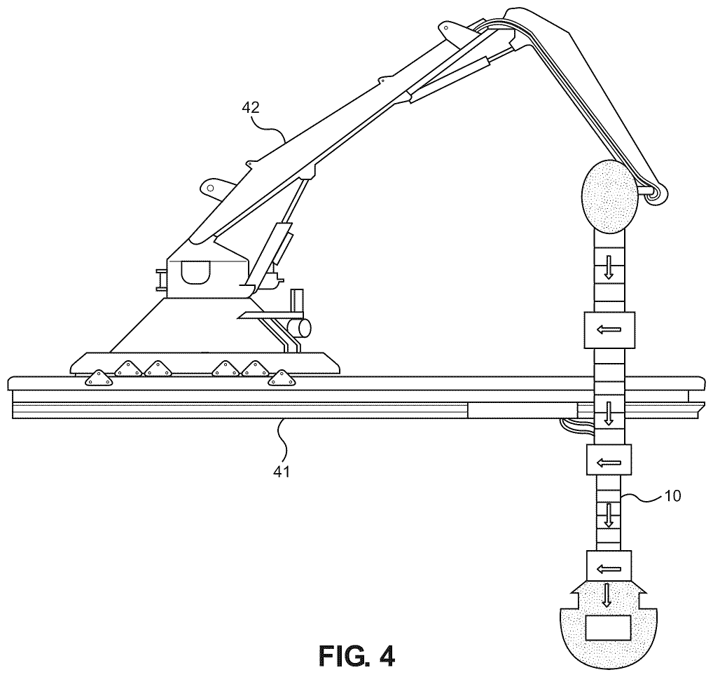

Referring now to FIG. 4, there is shown a demonstrative view of a ship-mounted embodiment of the submerged hydroelectric generator system 10 in use. In the illustrated embodiment, the submerged hydroelectric generator system 10 may be secured to a ship 41. Specifically, the ship 41 may comprise a movable arm 42 on which the submerged hydroelectric generator system 10 is installed on the distal end of. The movable arm 42 may be able to submerge the submerged hydroelectric generator system 10 and to enable the submerged hydroelectric generator system 10 to operate in an underwater location. By installing the submerged hydroelectric generator system 10 upon the ship 41, the submerged hydroelectric generator system 10 may be moved from one location to another. Furthermore, in some embodiments, the submerged hydroelectric generator system 10 may be used to power the ship's 41 engines and onboard power supply. The movement through the water from the ship's 41 motion enables zero net head pressure with less exhaust energy exhaust from the intake valve 14 and the outlet valve 15.

Referring now to FIG. 5, there is shown a perspective view of an embodiment of the submerged hydroelectric generator system 10. In the illustrated embodiment, the submerged hydroelectric generator system 10 may comprise a plurality of peg stocks 11. The plurality of peg stocks 11 may each comprise an independent intake valve 14 and at least one generator 16. The second end 13 of each peg stock 11 may be in operable connection with an outlet valve 15. As such, the outlet valve 15 may be able to expel water entering the submerged hydroelectric generator system 10 through all of the peg stocks 11.

In the specific embodiment, the outlet valve 15 may have a cuboctahedron shape 15AA. As such, each of the peg stocks 11 may be connected to a square face portion 15B of the cuboctahedron-shaped outlet valve 15AA. In the illustrated embodiment, each triangle portion 15C of the cuboctahedron-shaped outlet valve 15AA may comprise a turbofan engine 51. Alternatively, in other embodiments, the triangle portions 15C of the cuboctahedron-shaped outlet valve 15AA may comprise a low frequency sound system (FIG. 1, 15A), such that the water may be displaced from the outlet valve 15 through sound displacement. In the illustrated embodiment, the cuboctahedron-shaped outlet valve 15AA enables the inflow from the peg stocks 11 to create an internal whirlpool, which is displaced from the peg stock 11 by the actions of the outlet valve mechanisms disposed on the triangle portions 15C.

Referring now to FIG. 6, there is shown a perspective view of an alternate embodiment of the submerged hydroelectric generator system 10. In the illustrated embodiment, the generator 16 may be disposed at the first end 12 of the peg stock 11. The generator 16 may comprise a rotor 61 disposed at a distal end of a shaft 62 in operable connection with the generator 16. As such, when the rotor 61 is engaged by a water current from incoming water, the shaft 62 will rotate, creating energy that is preserved within the generator 16 for distribution.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A submerged hydroelectric generator system, comprising:
a peg stock comprising a first end and a second end;
an intake valve disposed on the first end of the peg stock;
at least one generator disposed within the peg stock;
an outlet valve disposed on the second end of the peg stock;
wherein the outlet valve is configured to release water from the peg stock;
wherein the peg stock is in a vertical configuration;
wherein the outlet valve comprises a low frequency sound system;
wherein the outlet valve comprises a plurality of aerator devices; and
wherein the outlet valve comprises an air vent.

2. The submerged hydroelectric generator system of claim 1, wherein the intake valve comprises a filter.

3. The submerged hydroelectric generator system of claim 1, wherein the intake valve comprises a valve regulator.

4. The submerged hydroelectric generator system of claim 3, wherein the valve regulator comprises a time valve system.

5. The submerged hydroelectric generator system of claim 1, wherein the at least one generator comprises a spindle generator.

6. The submerged hydroelectric generator system of claim 1, wherein the outlet valve comprises a vacuum-generation rotor that flushes water out of the peg stock.

7. The submerged hydroelectric generator system of claim 1, wherein the outlet valve comprises a turbofan engine that flushes water out of the peg stock.

8. The submerged hydroelectric generator system of claim 1, wherein the outlet valve comprises an air injection valve.

9. The submerged hydroelectric generator system of claim 1, wherein the low frequency sound system is a subwoofer.

10. The submerged hydroelectric generator system of claim 1, wherein the low frequency sound system produces sound that falls within the range of 20 Hz to 200 Hz.

11. The submerged hydroelectric generator system of claim 1, wherein the generator is disposed on the first end of the peg stock.

12. A submerged hydroelectric generator system, comprising:
a plurality of peg stocks each comprising a first end and a second end;
an intake valve disposed on the first end of each of the peg stocks;
at least one generator disposed within each of the peg stocks;
an outlet valve disposed on the second end of each of the peg stocks;
wherein the outlet valve is configured to release water from each of the peg stocks;
wherein the outlet valve has a cuboctahedron shape;
wherein the cuboctahedron shape includes a plurality of square face portions and a plurality of triangle portions;
wherein the peg stocks are connected to the square face portions of the cuboctahedron-shaped outlet valve; and
wherein the peg stocks are in a vertical configuration.

13. The submerged hydroelectric generator system of claim 12, wherein the intake valve comprises a filter.

14. The submerged hydroelectric generator system of claim 12, wherein the intake valve comprises a valve regulator.

15. The submerged hydroelectric generator system of claim 14, wherein the valve regulator comprises a time valve system.

16. The submerged hydroelectric generator system of claim 12, wherein the cuboctahedron-shaped outlet valve enables the inflow from the peg stocks to create an internal whirlpool.

17. The submerged hydroelectric generator system of claim 12, wherein each of the triangle portions of the cuboctahedron-shaped outlet valve comprises a turbofan engine.

18. The submerged hydroelectric generator system of claim 12, wherein the triangle portions of the cuboctahedron-shaped outlet valve comprise a low frequency sound system, such that water is displaced from the outlet valve through sound displacement.

19. The submerged hydroelectric generator system of claim 12, wherein the low frequency sound system is a subwoofer.

20. The submerged hydroelectric generator system of claim 12, wherein the low frequency sound system produces sound that falls within the range of 20 Hz to 200 Hz.
